(19) United States
(12) Patent Application Publication
(10) Pub. No.: US 2012/0254386 A1
(43) Pub. Date: Oct. 4, 2012

(54) Transfer of DNSSEC Domains

(75) Inventors: David Smith, Arlington, VA (US); James Gould, Leesburg, VA (US); David Blacka, Reston, VA (US)

(73) Assignee: VeriSign, Inc., Dulles, VA (US)

(21) Appl. No.: 13/078,643

(22) Filed: Apr. 1, 2011

(51) Int. Cl. G06F 15/173

(52) U.S. Cl. 709/223

(57) ABSTRACT

Systems and methods of transferring a DNSSEC enabled domain from a losing hosting provider to a gaining hosting provider are described in which the transfer of the domain may be achieved without disruption to a DNSSEC validation of the domain. Systems and methods, such as those directed to registry and/or registrar servers, may include transferring a DNSKEY or Delegation Signer (DS) record from a gaining hosting provider to a losing hosting provider prior to transferring the domain from the losing hosting provider to the gaining hosting provider. A gaining hosting provider may sign DNS records of the domain with the gaining hosting provider DNSKEY prior to transferring the domain from the losing hosting provider to the gaining hosting provider. Additionally, a registry server, or similar device, may be configured to act as an intermediary between the losing hosting provider and the gaining hosting provider during the transfer process.

### BACKGROUND OF THE INVENTION

The Domain Name System (DNS) is the part of the Internet infrastructure that translates human-readable domain names into the Internet Protocol (IP) numbers needed to establish TCP/IP communications over the Internet. That is, DINS allows users to refer to web sites, and other resources, using easier to remember domain names, such as “www.en.example.com,” rather than the numeric IP addresses, such as “123.4.56.78,” which are machine readable addresses used by software to communicate with computers on the Internet. Each domain name is made up of a series of character strings (labels) separated by dots. The right-most label in a domain name is known as the “top-level domain” (TLD). Examples of well-known TLDs are “.com”; “.net”; “.org.” etc. Each TLD supports second-level domains, listed immediately to the left of the TLD, e.g., “example” in “www.example.com.” Each second-level domain can support a number of third-level domains located immediately to the tell of the second-level domain, e.g., “en” in “www.en.example.com.” There can be additional level domains as well. For example, a domain with additional domain levels could be “www.landscape.photos.example.com.”

It should be noted that a single IP address, e.g., one assigned to a single server, can support numerous domain names. That is, different domain names may resolve to the same server, that can then determine what content to provide based on the requested domain Milne and/or additional non-domain information. This is sometimes referred to as virtual hosting.

Additional non-domain information may be included in a Uniform Resource Identifier (“URI”) structure that includes the domain name. For example, a “path” part is a sequence of segments separated by a forward slash (“/”). This information may be included immediately to the right of the domain name, such as the “blog” in “www.example.com/blog/today.htm,” and may be used by a server or other receiving device to identify and deliver specific content or run particular code. Other examples of non-domain information may include queries and fragments, the specifics of which are understood by those of ordinary skill in the art and are not discussed in detail herein. Combinations of this information may be included in web page hyperlinks that navigate a user to another section of the same page or to another web page.

Thus, as can be seen in the various examples provided above, and as appreciated by those of skill in the art, a domain, such as the second level domain “example.com”, may contain a variety of different Internet accessible information with different addresses and other means of identification.

The actual registration of domain names is performed by companies referred to as domain name registrars (“registrars”). Registrars register domain names with registries. For example, an end user submits to a registrar a domain name for registration and provides an IP address to which the domain name should resolve. The registrar communicates with the registry to create a registry database record that can be used to resolve the domain name to the IP address provided by the end user and indicates the identity of the registrar through which the domain name was registered. Except for the expiration of the domain name registration at the registry, typically only the registrar designated in the domain name record at the registry can modify or delete registry database information about a domain name. An end user can switch registrars by following certain domain transfer procedures. Registrars may also act as a hosting provider, or the end user may have the domain hosted by a separate third-party domain hosting service.

A zone file is a text file that describes a portion of the DNS called a DNS zone. A zone file is organized in the form of resource records (RR) and contains information that defines mappings between domain names and IP addresses and other resources. The format of zone files is defined by a standard, with each line typically defining a single resource record. A line begins with a domain name, but if left blank, defaults to the previously defined domain name. Following the domain name is the time to live (TTL), the class (which is almost always “IN” for “internet” and rarely included), the type of resource record (A, MX, SOA, etc.), followed by type-specific data such as the IPv4 address for A records. Comments can be included by using a semi-colon and lines can be continued by using parentheses. There are also file directives that are marked with a keyword starting with a dollar sign.

The DNS distributes the responsibility of assigning domain names and mapping those names to IP addresses by designating authoritative name servers for each domain. Authoritative name servers are assigned to be responsible for their particular domains, and in turn can assign other authoritative name servers for their sub-domains. This mechanism generally helps avoid the need for a single central register to be continually consulted and updated. The DNS resolution process allows for users to be directed to a desired domain by a reverse lookup process whereby the user enters the desired domain, and the DNS returns appropriate IP numbers. During the DNS resolution process, a request for a given domain name is routed from a resolver (e.g. a stub resolver) to an appropriate server (e.g. a recursive resolver) to retrieve the IP address. To improve efficiency, reduce DNS traffic across the Internet, and increase performance in end-user applications, the DNS supports DNS cache servers that store DNS query results for a period of time determined by the time-to-live (TTL) of the domain name record in question. Typically, such caching DNS servers, also called DNS caches, also implement the recursive algorithm necessary to resolve a given name starting with the DNS root through to the authoritative name servers of the queried domain. Internet service providers (ISPs) typically provide recursive and caching DNS servers for their customers. In addition, home networking routers may implement DNS caches and proxies to improve efficiency in the local network.

Although the distributed nature of the DNS provides significant advantages in terms of the efficiency of the overall system it also makes the system vulnerable to certain types of malfunctions and/or attacks at various nodes in the system. One particular problem that can occur is referred to as DNS cache poisoning. DNS cache poisoning occurs when data are introduced into a DNS name server's cache database that did not originate from authoritative DNS sources. This may result from deliberate attacks on a name server, or it may be an unintended result of, for example, a misconfigured DNS cache or improper software design of a DNS applications. Thus, DNS cache poisoning can result in (1) resolution requests failing, such as when inaccurate or misconfigured IP address information is provided, or (2) a requesting user's resolution request being directed to a malicious site that spoofs the genuine domain and is used to illicitly obtain information such as account passwords, or to distribute malicious content, such as computer worms or viruses, that are delivered to the requesting user.

The Domain Name System Security Extensions (DNSSEC) is a suite of Internet Engineering Task Force (IETF) specifications for securing certain kinds of information provided by the DNS as used on IP networks. DNSSEC provides for the signing of DNS-ready zone files, ensuring origin authentication and data integrity for DNS data, as well as authenticated denial of existence. In general, answers provided within DNSSEC are digitally signed, and, by checking the digital signature, a DNS resolver is able to check if the information corresponds to the information on the authoritative DNS server. DNSSEC uses public-key cryptography for the digital signatures and authentication. The DNSKEY record is authenticated via a chain of trust, starting with a set of verified public keys for the DNS root zone, which is a trusted third party.

To implement DNSSEC, several new DNS record types were created or adapted to use with DNSSEC, including RRSIG, DNSKEY, DS, NSEC, NSEC3 and NSEC3PARAM. For example, when DNSSEC is used, each authoritative answer to a DNS lookup will contain an RRSIG DNS record in addition to the record type that was requested. The RRSIG record is a digital signature of the answer DNS resource record set. The digital signature can be verified by locating the correct public key found in a DNSKEY record. The DS record is used in the authentication of DNSKEYs in the lookup procedure using the chain of trust. NSEC and NSEC3 records are used to provide the authenticated denial of existence responses for DNS records that do not exist.

The requirements of DNSSEC involve the use of different keys, stored both in DNSKEY—records and from other sources to form trust anchors. There are, for example, Key Signing Keys (KSKs), which are used to sign other DNSKEY records, and Zone Signing Keys (ZSKs), which are used to sign other records. Because the ZSKs are under the control and use of a specific DNS zone, they can be switched more easily and more often. As a result, ZSKs can generally be much shorter (in terms of byte length than KSKs, while still offering an acceptable level of protection.

Although protocols have been developed for the employment of DNSSEC, including the use of KSKs and ZSKs, there are numerous aspects of operating DNSSEC enabled domains, at the registrar and registry levels, that have not been addressed and/or optimized for large-scale use. Accordingly, there are ongoing needs to further improve the functionality and/or efficiency of operations related to DNSSEC management.

### SUMMARY OF THE INVENTION

With the introduction of DNSSEC into vast registries, such as the .com and .net registries, DNS hosting transfer of a DNSSEC enabled domain brings with it the potential for resolution problems. Such problems may result in domains not resolving securely, or not resolving at all, which can have significant detrimental effects on e-commerce and other high-traffic sites. For DNSSEC, enabled domains, in addition to managing the switchover of nameservers, the change in registrars and/or hosts involves managing the Delegation Signer (DS) resource records in the parent zone and the list of DNSKEY records across the old and new child zones to ensure that the DNSSEC chain will continuously validate during the transfer. The present subject matter may provide benefits in the efficient transfer of DNSSEC enabled domains amongst registrars and/or hosting providers.

Embodiments may include systems and methods for transferring a DNSSEC enabled domain from a losing hosting provider to a gaining hosting provider. In embodiments, a request to transfer the domain from the losing hosting provider to the gaining hosting provider may be received, for example, at the gaining hosting provider, the losing hosting provider, or a registry for the domain. The transfer request may be received from the registrant of the domain. Embodiments may include transferring a DNSKEY and/or Delegation Signer (DS) record from the gaining hosting provider to the losing hosting provider prior to transferring the domain from the losing hosting provider to the gaining hosting provider. Embodiments may include signing DNS records of the domain with the gaining hosting provider DNSKEY prior to transferring the domain from the losing hosting provider to the gaining hosting provider.

Embodiments may include transferring hosting of the domain from the losing hosting provider to the gaining hosting provider. In addition, the domain hosting may be transferred from the losing hosting provider to the gaining hosting provider without interruption to a DNSSEC validation for the domain.

Embodiments may include determining a TTL for some, or all, of DNS records of the domain. The TTLs may be determined by, for example, the gaining hosting provider, the losing hosting provider, and/or the registry for the domain. In embodiments, the transfer of the hosting of the domain may be executed after expiration of a longest TTL of DNS records of the domain.

Embodiments may include establishing an undelegated DNSSEC enabled zone for the domain at the gaining hosting provider, and delegating the DNSSEC enabled zone after expiration of a longest TTL of the DNS record TTLs.

In embodiments, the losing hosting provider may be supported by a losing registrar and the gaining hosting provider may be supported by a gaining registrar. Embodiments may include receiving the transfer request at the gaining registrar to transfer the domain from the losing registrar to the gaining registrar, and/or establishing an unpublished DNSSEC enabled zone for the domain at the gaining registrar. Embodiments may also include transmitting from the gaining registrar at least one of DNSKEY and Delegation Signer (DS) records for the zone. In embodiments, the DNSKEY records for the zone may include a key-signing key (KSK).

In embodiments, domain authorization information for the domain may be received at the gaining registrar and/or the registry for the domain. An initiation request may be received at the gaining registrar to initiate the transfer of the domain, and, after receiving the initiation request, a registry request may be sent from the gaining registrar to a registry responsible for the domain. The registry request may include the domain authorization information. In embodiments, the initiation request may be sent by, and/or received from, the registrant of the domain, or the losing registrar.

In embodiments, the gaining registrar may automatically confirm that at least one of (a) the DNSKEY records have been published, and (b) the Delegation Signer (DS) records have been added to the domain by the registry. A sending of the registry request may be conditioned on the automatic confirmation of the DNSKEY records having been published, and/or the Delegation Signer (DS) records having been added to the domain by the registry.

According to further aspects of the invention, embodiments may include systems and methods for transferring a DNSSEC enabled domain in which a registry server, or the like, may facilitate the transfer by acting between the losing and gaining hosting providers. For example, embodiments may include receiving, at a registry for the domain, at least one of DNSKEY and Delegation Signer (DS) records for the domain from a gaining registrar. Embodiments may include providing, from the registry, the at least one of DNSKEY and Delegation Signer (DS) records to a losing registrar.

In embodiments, the registry may confirm, or receive confirmation, that the losing registrar has changed an existing DNSSEC data for the domain based on the at least one of DNSKEY and Delegation Signer (DS) records. In embodiments, the registry may receive the confirmation that the losing registrar has changed the existing DNSSEC data for the domain from the gaining registrar, the losing registrar, and/or the registrant. The registry may change address information for the domain, e.g. address information stored by the registry, after the confirmation that the existing DNSSEC data for the domain has been changed.

In embodiments, the registry, or other third-party provider, may determine a longest TTL for all DNS records of the domain, and/or, after expiration of a longest TTL, may send an initiation request from the registry to the losing registrar. In embodiments, the initiation request may include a request for authorization information for the domain. In embodiments, after receiving the authorization information, the registry, or other third party provider, may communicate the authorization information to the gaining registrar.

According to further aspects of the invention, embodiments may include hosting provider server systems with one or more processors and a storage medium including instructions for configuring the processor(s) to perform steps for transferring hosting of a. DNSSEC-enabled domain. Embodiments may include instructions for configuring the processor to receive, recognize, respond to, and/or act on a request to transfer the DNSSEC-enabled domain from a losing hosting provider to a gaining hosting provider. In embodiments, the processor may be configured to transfer a DNSKEY or Delegation Signer (DS) record from the gaining hosting provider to the losing hosting provider prior to transferring the domain from the losing hosting provider to the gaining hosting provider. In embodiments, the processor may be configured to transmit the DNSKEY and/or Delegation Signer (DS) records for the undelegated zone from the gaining hosting provider to a registrant of the domain, a registry of the domain, and/or the losing hosting provider. In embodiments, the DNSKEY records for the undelegated zone may include a key-signing key (KSK).

In embodiments, such as when the processor is included in a server at the losing hosting provider, the processor may be configured to sign DNS records of the domain with the gaining hosting provider DNSKEY prior to transferring the domain from the losing hosting provider to the gaining hosting provider.

In embodiments, the processor may be configured to transfer hosting of the domain from the losing hosting provider to the gaining hosting provider, and may be further configured such that the domain hosting is transferred from the losing hosting provider to the gaining hosting provider without interruption to a DNSSEC validation for the domain.

In embodiments, the processor may be configured to determine a TTL for some, or all, of DNS records of the domain, and/or transfer hosting of the domain after expiration of a longest TTL of DNS records of the domain.

In embodiments, the processor may be configured to establish an undelegated DNSSEC enabled zone for the domain at the gaining hosting provider and/or delegating the DNSSEC enabled zone after expiration of a longest TTL of the DNS record TTLs.

In embodiments, the losing hosting provider may be supported by a losing registrar and the gaining hosting provider may be supported by a gaining registrar, and the processor may be further configured to perform one or more steps of (1) receive the transfer request at the gaining registrar to transfer the domain from the losing registrar to the gaining registrar; (2) establish an unpublished DNSSEC enabled zone for the domain at the gaining registrar; (3) transmit from the gaining registrar at least one of DNSKEY and Delegation Signer (DS) records for the zone; (4) receive domain authorization information for the domain at the gaining registrar; (5) receive an initiation request at the gaining registrar to initiate the transfer of the domain; and/or (6) after receiving an initiation request, send a registry request from the gaining registrar to a registry responsible for the domain. The registry request may include the domain authorization information.

In embodiments, the processor may be further configured to automatically confirm that at least one of (a) the DNSKEY records have been published, and (b) the Delegation Signer (DS) records have been added to the domain by the registry. In embodiments, the sending of the registry request by the processor may be conditioned on the automatic confirmation of the DNSKEY records having been published, and/or the Delegation Signer (DS) records having been added to the domain by the registry.

According to further aspects of the invention, embodiments may include a registry server system including a processor and a storage medium including instructions for configuring the processor to perform steps for transferring hosting of a DNSSEC-enabled domain. Embodiments may include instructions for configuring the processor to receive, at a registry responsible for the domain, at least one of DNSKEY and Delegation Signer (DS) records for the domain from a gaining registrar. Embodiments may include instructions for configuring the processor to send, from the registry, the at least one of DNSKEY and Delegation Signer (DS) records to a losing registrar, and/or a registrant of the domain.

In embodiments, the processor of the registry server may be further configured to automatically confirm that the losing registrar has changed an existing DNSSEC data for the domain based on the at least one of DNSKEY and Delegation Signer (DS) records. In embodiments, the confirmation may be obtained from the losing registrar, the gaining registrar, or the registrant, and/or verified by the registry. Embodiments may include instructions for configuring the processor to change address information for the domain at the registry after the confirmation that the existing DNSSEC data for the domain has been changed.

In embodiments, the processor may be further configured to automatically determine a longest TTL for some, or all, of DNS records of the domain. The processor may be configured to send an initiation request from the registry to the losing registrar to request authorization information for the domain. In embodiments, the processor may be configured to send the initiation request after expiration of the longest TTL. The processor may be configured to communicate authorization information from the registry to the gaining registrar, e.g. after receiving the authorization information from the losing registrar.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 depicts relationships within a DNS system according to aspects of the invention.

FIG. 2 depicts an exemplary process flow for transferring a DNSSEC-enabled domain according to first aspects of the invention.

FIG. 3 depicts relationships within a DNS system according to further aspects of the invention.

FIG. 4 depicts another exemplary process flow for transferring a DNSSEC-enabled domain according to further aspects of the invention.

FIG. 5 depicts another exemplary process flow according to yet further aspects of the invention in which a registry may facilitate transfer of a DNSSEC-enabled domain.

FIG. 6 depicts an exemplary computer network architecture as may be used in embodiments of the invention.

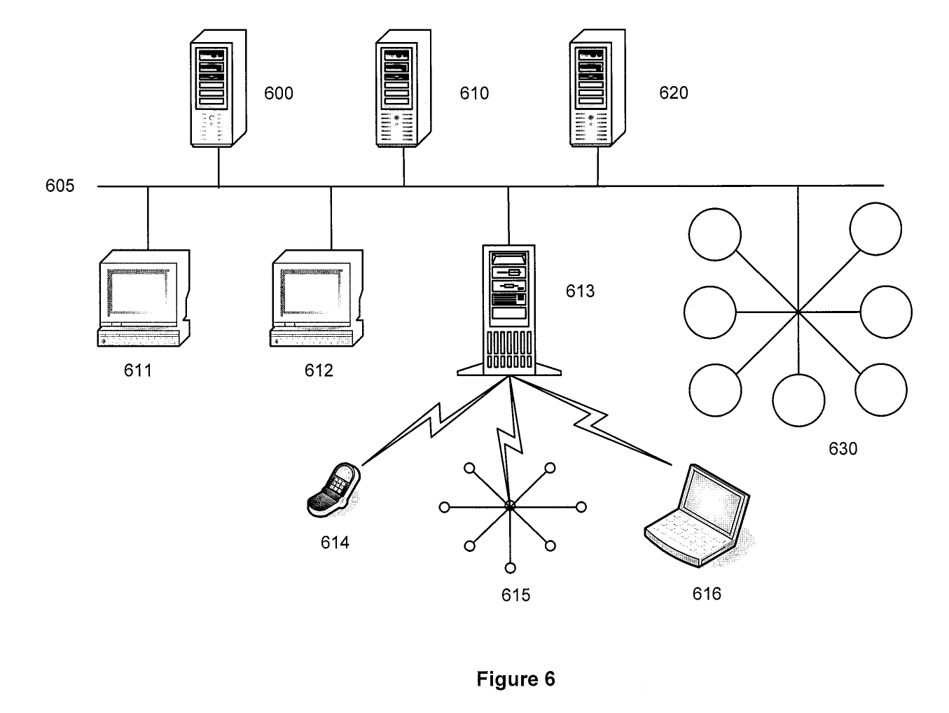

### DETAILED DESCRIPTION OF THE INVENTION

It is understood that the invention is not limited to the particular methodology, protocols, and reagents, etc., described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise. Thus, for example, a reference to “a server” is a reference to one or more server and equivalents thereof known to those skilled in the art.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

As used herein, unless otherwise limited, a registrar may be understood to be any entity or organization that interacts with a domain-name registry and allows registrants to create and update domain-name resources.

As used herein, unless otherwise limited, a registrant may be understood to be any person or organization that interacts with a registrar to create and update a domain-name resource.

As used herein, unless otherwise limited, a DNS hosting provider may be understood to be any entity or organization that hosts content on its servers on behalf of a registrant, providing DNS provisioning and resolution capabilities for that content (e.g., assigns IP addresses and operates nameservers capable of resolving domain names to those IP addresses that it manages).

According to aspects of the present invention, systems and methods for supporting a domain-sponsorship transfer with DNS hosting transfer may include, for example, a domain transfer between registrars, which may be referred to as a “domain-sponsorship transfer,” and a transfer in DNS hosting, which may be referred to as a “DNS hosting transfer.” in the case of domain transfers, both transfers may typically be included because many registrars are DNS hosting providers, and registrants often take advantage of the DNS hosting provided by their registrars. The following example shows the steps involved in a domain-sponsorship transfer between registrars that includes a DNS hosting transfer between those same registrars.

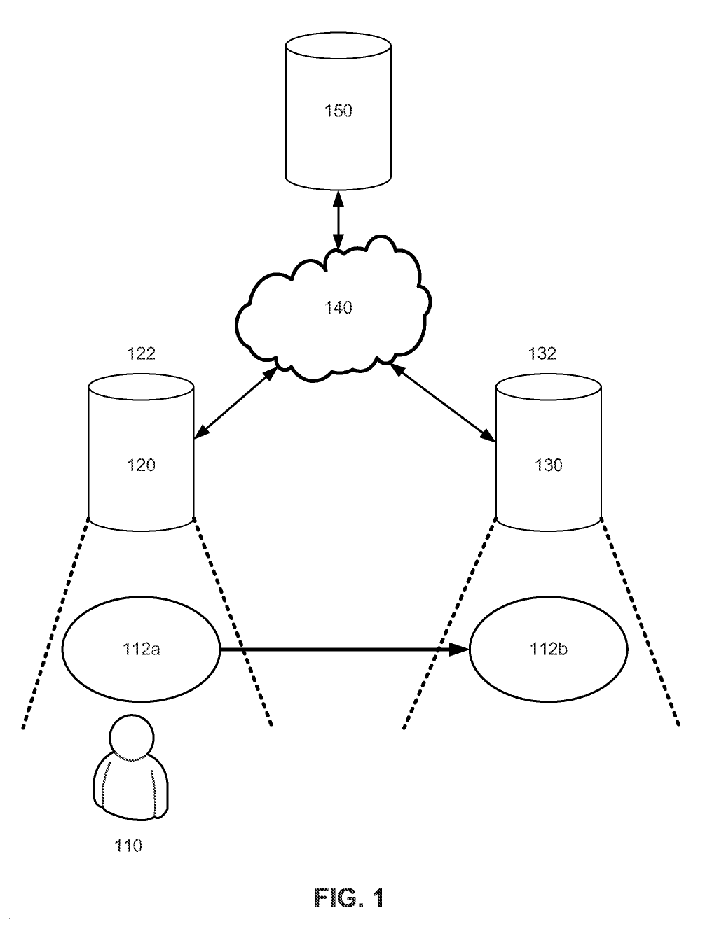

As shown in FIG. 1, a registrant 110 may have a DNSSEC enabled domain 112a that is hosted by a registrar 122 providing hosting services on server 120. For purposes of this discussion the registrar 122 associated with server 120 may be referred to as the “losing registrar.” The domain 112a may further be under and supported by a TLD registry represented by server 150. The registrant 110 may desire to transfer control of the domain 112a to another registrar 132 providing hosting services on server 130. For purposes of this discussion the registrar 132 associated with server 130 may be referred to as the “gaining registrar.” The gaining registrar associated with server 130 may further be under and supported by the TLD registry represented by server 150. Each of the servers 120, 130 and 150, as well a computing device (not shown) operated by the registrant 110, may be in communication via the Internet, generally depicted as cloud 140.

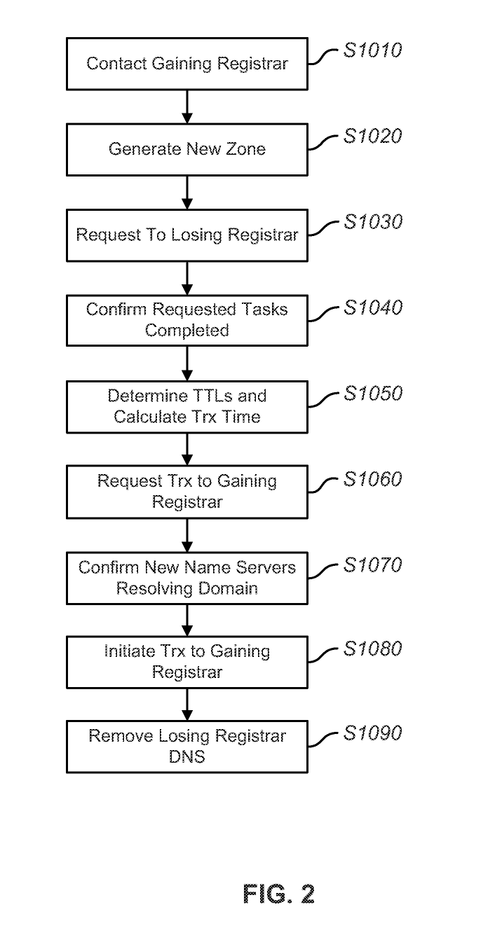

Further details regarding an exemplary transfer are described with additional reference to FIG. 2. As shown in FIG. 2, a transfer may begin with step S1010 when registrant 110 contacts gaining registrar 132 about transferring control of the domain 112a to them. This communication, as well as others described herein, may typically be accomplished electronically over the Internet, and may include various security and validation features known to those of skill in the art. The request may include domain identifying information and any amount of other information required to establish the domain with the gaining registrar 132. The method may continue with S1020.

In S1020, gaining registrar 132 may set up a DNSSEC-enabled zone for the domain 112a (e.g. “example.com”). Establishing the zone may include generating a ZSK, and a DS record. In embodiments, the new zone may not be published publicly, i.e. not yet put into the resolution path, which obscures it to typical Internet users. As part of establishing the new zone, gaining registrar 132 may communicate to registrant 110 information including, for example, the DNSKEY records in the new zone for the KSK and ZSK, and the DS record, which may be published in a parent zone maintained by the registry 150. The method may continue with S1030.

In S1030, registrant 110 may contact losing registrar 1122 and request one or more of the following:

a. Publish the gaining registrar 132-generated DNSKEY records and re-sign the DNSKEY RR set in the losing registrar 122-managed zone.
b. Add the gaining registrar 132-generated DS record to the domain 112a by contacting the registry 150.
c. Shorten the TTL of DNSKEY and NS records in losing registrar 122's zone for domain 112a.
d. Send registrant 110 the authorization info (“authinfo”) for domain 112a, e.g. so that registrant 110 can pass that along to gaining registrar 132 to begin the actual domain transfer.

In embodiments, shortening a TTL for DNSKEY and NS records may provide advantages in facilitating a smooth transfer to the gaining registrar 132 at the appropriate time. For example, a TTL of 10 minutes, which would be 600 (seconds) in TTL terms, may be sufficient to allow for relatively stable and expeditious transfer of the domain when all other formalities are completed. The method may continue with S1040.

In S1040, it is conformed that the tasks requested in S1020 have been completed. For example, registrant 110 may verify that losing registrar 122 has performed all of the requested actions. Alternatively, gaining registrar 132 may verify one or more of these tasks. As part of this process, or separately in S1050, the TTLs of all involved DNS records for the domain 112a may also be determined. This may be determined by the registrant 110, the gaining registrar 132, or the registry 150. The DNS records may include losing registrar 122's DNSKEY, RRSIG, and NS records, as well as the DS records in the TLD registry 150.

In embodiments, the longest of the DNS record TTLs may be used in S1050 to determine how long registrant 110, gaining registrar 132, and/or registry 150 will wait before initiating the actual switch of domain 112a from the name servers of losing registrar 122 to the name servers of gaining registrar 132. For example, automated processes of registrant 110, gaining registrar 132, and/or registry 150 may be configured to add the longest TTL to the current time, to calculate a time for initiating a switch to gaining registrar 132's name servers. By way of further example, if the TTLs of losing registrar 122 records are all set to 24 hours, and the TTL of the domain 112a DS record is set to 48 hours, the longest of these is 48 hours, systems and methods may set a delay of 48 hours after all changes have been made to initiate the switch.

After expiration of the longest Fit, the method may continue with S1060. In S1060, the registrant 110, gaining registrar 132, and/or registry 150 may send a request to losing registrar 122 to contact the registry 150 in order to:

a. Remove all of losing registrar 122's name servers from domain 112a.
b. Add in gaining registrar 132's name servers for domain 112a.

The above requests may be used to smoothly facilitate the transfer of management for the domain 112a from the losing registrar 122 to the gaining registrar 132 without an interruption in service by pre-populating the name server information for the gaining registrar before the domain 112a is transferred to gaining registrar 132. The method may continue with S1070.

In S1070, registrant 110, gaining registrar 132, and/or registry 150 may verify that the new gaining registrar 132 name servers are resolving domain 112a after the TTLs of the losing registrar 122 NS records have expired. The method ma continue with S1080.

In S1080, registrant 110, gaining registrar 132, and/or registry 150 may initiate the necessary requests to a request to execute the domain transfer of domain 112a to gaining registrar 132. For example, registrant 110, gaining registrar 132, and/or registry 150 may initiate a request to gaining registrar 132 to execute the domain transfer of domain 112a to gaining registrar 132. Gaining registrar 132 may also contact registry 150 and file a transfer request for domain 112a, supplying the domain's auth info. The registry request may be communicated by, for example, Extensible Provisioning Protocol (EPP).

Losing registrar 122 may communicate an approval of the transfer request to registry 150. In embodiments, the registry 150 may be configured to automatically approve the domain transfer request after a predetermined period of time, e.g. 5 days, if no response is received from the losing registrar 122. After the registry 150 has made the necessary changes to their records to reflect the transfer of domain 112a to, now, domain 112b under control of gaining registrar 132, the method may continue with S1090.

In S1090, gaining registrar 132 may remove losing registrar 122's DS record for domain 112b. For example, registrant 110 may contact gaining registrar 132 and request gaining registrar 132 to remove losing registrar 122's DS record for domain 112b.

According to aspects of the invention, the above steps and automated processes may be used to address particular problems associated with the DNSSEC files included in the DNS hosting transfer from losing registrar 122 to gaining registrar 132. For example, the hosting transfer of domain 112a discussed above takes into account the various caching resolvers in the DNS and ensures that, for every caching resolver:

a. Gaining registrar 132's DS record are added to the cache before the domain is referred to gaining registrar 132's nameservers that resolve domain 112b.
b. Gaining registrar 132's DNSKEYs are added to the cache before attempting to validate any signatures generated with those DNSKEYs.

Additionally, introducing DNSSEC into resolutions results in multiple RRs where caching can cause issues during a DNS hosting transfer. These RRs include, for example, the NS, DS, and RRSIG records in the parent zone of registry 150 (e.g. .com) and the DNSKEY and RRSIG records in the child zone of the domain (e.g. example.com). For instance, with respect to DNSKEY RRs, when domain 112a switches nameservers, some resolvers could, due to their caching, still have losing registrar 122's DNSKEY as being authoritative when resolving domain 112a even though gaining registrar 132's nameservers, and thus gaining registrar 132's DNSKEY, have become the new authoritative sources of information for domain 112a. This could result in resolvers receiving signed DNS records from gaining registrar 132 but have only losing registrar 122's cached DNSKEY against which to verify the signed records, which would necessarily fail. Accordingly, aspects of the invention may be used to address various DNS resource records having their own TTLs by, for example, pre-publishing new DNS records for gaining registrar 132, and waiting appropriate amounts of time before executing certain of the steps listed above, so that any caching resolver, no matter what records it is caching and when those records expire, will always view DNSSEC chains of trust as valid.

Similar caching issues may also be addressed with regard to the records in the parent zone (e.g. .com), where the DS RRs are housed for the domain and returned by the nameservers when those nameservers provide referrals for the domain. Caching resolvers will not know about gaining registrar 132's DS RR until they check back with the TLD nameservers, and they will do this cache refresh only when the TTL expires on the DS records they last fetched. Therefore, there could be a period of time where caching resolvers would not know about the gaining registrar 132's DS record even though it has been published in the TLD zone, and during that period of time, it would not be stable to have gaining registrar 132's nameservers receive DNSSEC-validating traffic. According to aspects of the invention, this problem may be addressed by, for example, pre-publishing the DS of the gaining registrar in the registry by the registrant and/or registry interfacing with the losing registrar, and waiting for a maximum TTL to transfer hosting of the domain.

The foregoing method also provides stability and security without requiring key transfers from the losing registrar to the gaining registrars. For example, the losing registrar 122 need not share its private key with the gaining registrar 132, and thus the gaining registrar would not be able to create any digital signatures using that key.

According to aspects of the invention, automated transfer of domain hosting may include the losing DNS hosting provider, in this case losing registrar 122, allowing the registrant to submit new DNSKEY's, in this case the keys from gaining registrar 132, into the registrant's zone. This may also include the losing provider re-signing the DNSKEY RR set. The losing registrar 122, may also allow the registrant to submit DS-record information, in this case from gaining registrar 132's key-signing key, for domain 112a, which the losing registrar 122 may send on to the registry 150. Such steps may be accomplished in similar manner to those that allow registrants to enter nameserver information for their domains and the like. According to embodiments, registrar servers, such as servers 120, 130 in FIG. 1, may be configured to automatically process such requests in response to electronic communications such as through web pages, and/or one or more of the steps may be accomplished through customer-service phone calls, email requests, or other mechanisms.

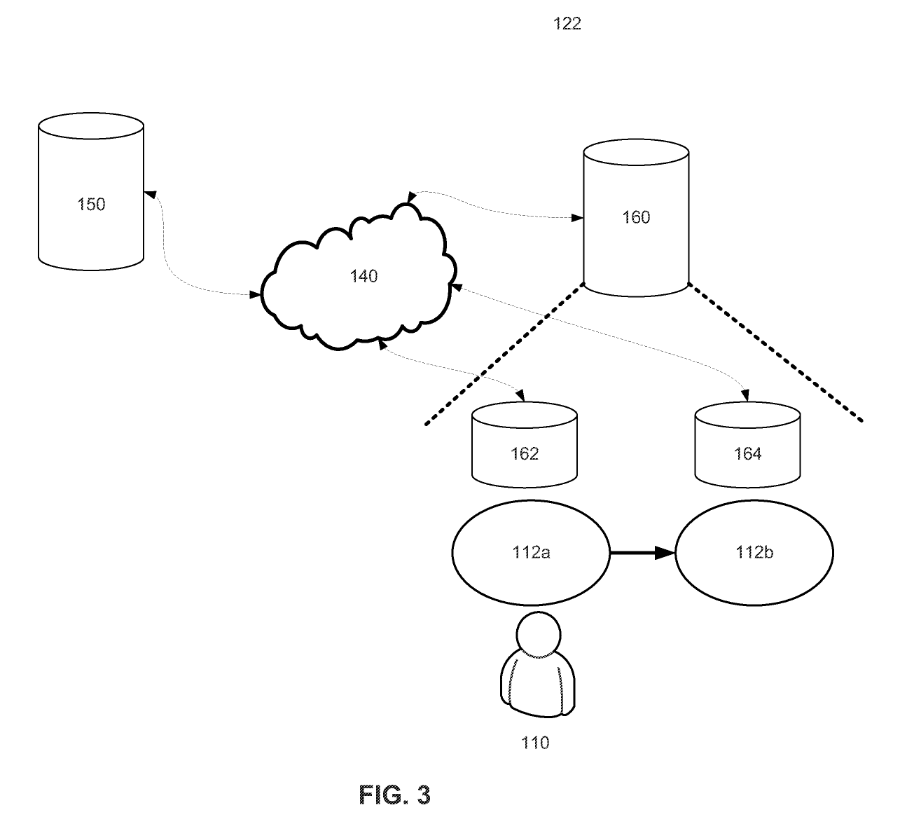

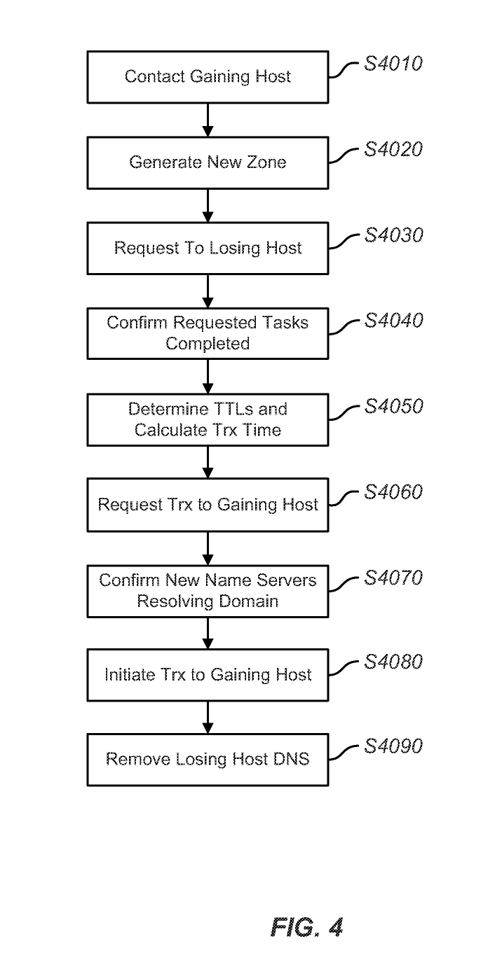

According to other aspects of the invention, similar DNSSEC-enabled domain transfers may be supported in situations when domain sponsorship does not change (i.e., the registrant continues with the same registrar) but the registrant elects to move from one hosting provider to another. Aspects of such methods are described below with reference to FIGS. 3-4.

As shown in FIG. 3, a registrant 110 may have a DNSSEC enabled domain 112a that is hosted by a domain hosting provider 162 under registrar 160. For purposes of this discussion the domain hosting provider 162 may be referred to as the “losing hosting provider.” As with the example discussed with regard to FIGS. 1 and 2, the domain 112a may further be under and supported by a TLD registry represented by server 150. The registrant 110 may desire to transfer control of the domain 112a to another domain hosting provider 164, also under the registrar 160. For purposes of this discussion the domain hosting provider 164 may be referred to as the “gaining hosting provider,” Each of the servers of registry 150, registrar 160, losing hosting provider 162, and gaining hosting provider 164, as well a computing device (not shown) operated by the registrant 110, may be in communication via the Internet, generally depicted as cloud 140.

Further details regarding an exemplary transfer between hosting providers are described with additional reference to FIG. 4. As shown in FIG. 4, a transfer may begin with step S4010 when registrant 110 contacts gaining hosting provider 164 about transferring control of the domain 112a to them. This communication, as well as others described herein, may typically be accomplished electronically over the Internet, and may include various security and validation features known to those of skill in the art. The request may include domain identifying information and any amount of other information required to establish the domain with the gaining hosting provider 164. The method may continue with S4020.

In S4020, gaining hosting provider 164 may set up a DNSSEC-enabled zone for the domain 112a (e.g. “example.com”). Establishing the zone may include generating a ZSK, and a DS record. In embodiments, the new zone may not be published publicly, i.e. not yet put into the resolution path, which obscures it to typical Internet users. As part of establishing the new zone, gaining hosting provider 164 may communicate to registrant 110 information including, for example, the DNSKEY records in the new zone for the KSK and ZSK, and the DS record, which may be published in a parent zone maintained by the registry 150. The method may continue with S4030.

In S4030, registrant 110 may contact losing hosting provider 162 and request one or more of the following:

a. Publish the gaining hosting provider 164-generated DNSKEY records and re-sign the DNSKEY RR set in the losing hosting provider 162-managed zone.
b. Shorten the TTL of DNSKEY and NS records in losing hosting provider 162's zone for domain 112a.

As discussed previously, shortening a TTL for DNSKEY and NS records may provide advantages in facilitating a smooth transfer of the domain at the appropriate time. The method may continue with S4040.

In S4040, registrant 110 contacts registrar 160, and requests registrar 160 to add the gaining hosting provider 164-generated DS record to the domain 112a by contacting the registry 150. The method may continue with S4050.

In S4050, it is confirmed that the tasks requested in S4030 have been completed. For example, registrant 110 may verify that losing hosting provider 162 has performed all of the requested actions. Alternatively, gaining hosting provider 164 may verify one or more of these tasks. As part of this process, or separately in S4060, the TTLs of all involved DNS records for the domain 112a may also be determined. This may be determined by the registrant 110, the gaining hosting provider 164, or the registry 150. The DNS records may include losing hosting provider 162's DNSKEY, RRSIG, and NS records, as well as the DS records in the TM registry 150.

In embodiments, the longest of the DNS record TTLs may be used in S1060 to determine how long registrant 110, gaining hosting provider 164, and/or registry 150 will wait before initiating the actual switch of domain 112a from the name servers of losing hosting provider 162 to the name servers of gaining hosting provider 164. For example, automated processes of registrant 110, gaining hosting provider 164, and/or registry 150 may be configured to add the longest TTL to the current time, to calculate a time for initiating a switch to gaining hosting provider 164's name servers. By way of further example, if the TTLs of losing hosting provider 162 records are all set to 24 hours, and the TTL of the domain 112a DS record is set to 48 hours, the longest of these is 48 hours, systems and methods may set a delay of 48 hours after all changes have been made to initiate the switch.

After expiration of the longest TTL, the method may continue with S4070. In S4070, the registrant 110, gaining hosting provider 164, and/or registry 150 may send a request to registrar 160 to contact the registry 150 in order to:

a. Remove all of losing hosting provider 162's name servers from domain 112a.
b. Add in gaining hosting provider 164's name servers for domain 112a.
c. Remove losing hosting provider 162's DS record for domain 112a.

The registrar 160 may then take the necessary steps to accomplish the remaining tasks without further involvement of the losing hosting provider 162. For example, the registrar may independently coordinate with the registry 150 to remove the losing hosting provider 162's name servers from domain 112a, add in gaining hosting provider 164's name servers for domain 112a, and remove losing hosting provider 162's DS record for domain 112a.

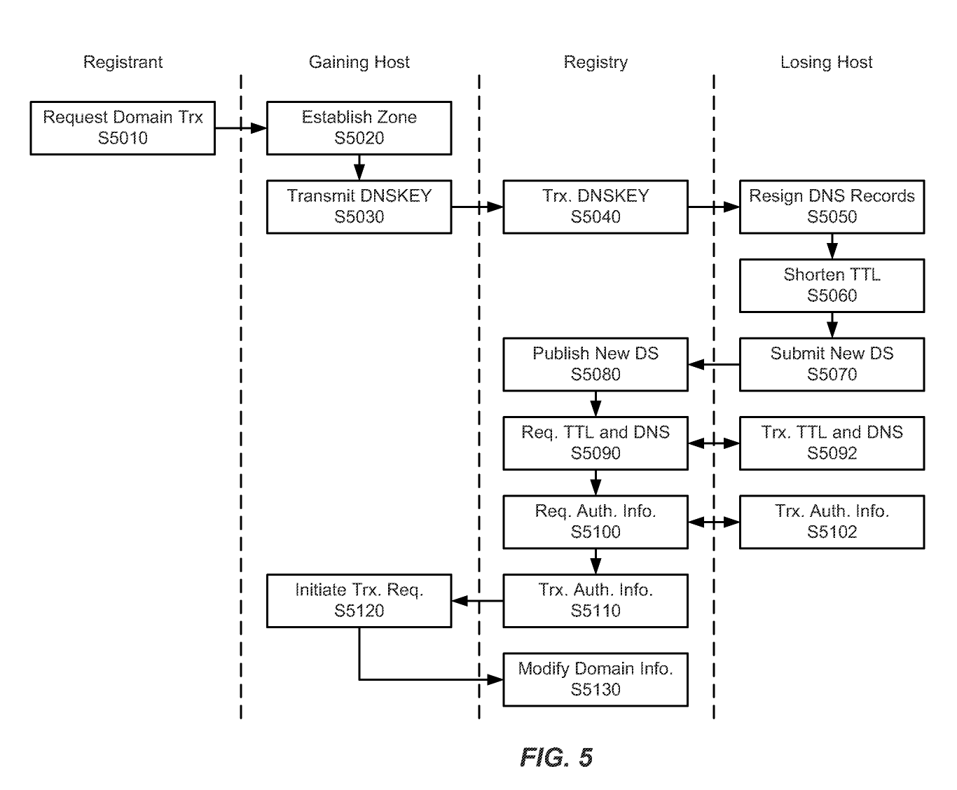

According to further aspects of the invention, when a DNSSEC-enabled domain is transferred from one registrar to another, and when both of those registrars provide DNSSEC enabled hosting of the domain, the registry, e.g. registry 150, or other device with similar functionality, may facilitate the transfer in ways not done for non-DNSSEC transfers. For example, the registry may use its position as the nexus between the two registrars to communicate to the registrars events and data specific to DNSSEC that will enable those registrars to effect the smooth transfer of the domain while preventing the domain from losing DNSSEC validation, or losing accessibility from cache servers, as a result of improper DNSSEC data in the DNS. An example of such a method is described with reference to FIG. 5.

As shown in FIG. 5, such a process may begin in S5010 with the registrant contacting a gaining host to request a domain transfer to the gaining host. As mentioned previously, such communications may be made in an automated manner such as e-mails, web page interaction, and the like via the Internet, or other communication networks. In embodiments, the gaining host may authenticate the transfer request in various ways, which may be similar to other DNS transfer protocols known in the art, to ensure that the requestor has the right to order transfer of the domain. The method may continue with S5020.

Once the gaining host has sufficient information from the registrant, or other accessible sources with information regarding the domain to be transferred, the gaining host, which may be a registrar that also provides hosting services, may establish a new DNSSEC-enabled zone for the domain in S5020. Establishing the new zone may include, for example, generating a DS record for the KSK's DNSKEY record as well as other tasks mentioned above, and may also identify the nameservers that eventually will be used for resolution of the domain being transferred. The method may continue with S5030.

In S5030, the gaining host/registrar may communicate to the registry responsible for the domain one or more of the DNSKEY data from the new zone, the DS record for the KS K's DNSKEY record, and the nameservers that will be used for resolution of the domain being transferred. Such communications may be automated and may interact with a registry server system that is configured to recognize, respond to and/or act on such requests, such as, for example, via EPP message. The registry may perform validation of the request to ensure that the gaining host has received permission from the registrant to transfer the domain to the gaining host. This process may be based on information included in the request, and/or involve sending requests to a registrant at a pre-designated address for confirmation. Once the request is validated by the registry, the method may continue with S5040.

In S5040, the registry may communicate one or more of the DNSKEY data from the new zone, and the DS record for the KSK's DNSKEY record to the losing host/registrar. Such communications may be accomplished by various methods known in the art such as sending it via a standard message protocol to the losing host (e.g. by poll message) and/or otherwise making the information available for the losing host to pull from the registry. In addition, the registry may request that the losing host, and/or other cached servers that communicate with the registry, to reduce the TTLs for the domain's DNS records to a desired time. This time will typically be shorter than the existing TTLS for the records in order to facilitate a smooth and relatively rapid transition of the domain from the losing host once all other tasks are completed. The method may continue with S5050.

In S5050, the losing registrar puts the new DNSKEY record into the existing zone and resigns the DNSKEY record set for the domain. Accordingly, the DNSKEY record set is put in a state that can maintain consistency when the domain is transferred from the losing host to the gaining host. The losing host/registrar may also shorten the TTL of the DNSKEY and NS records for the zone to the requested time in S5060. After these changes are made, resolvers accessing the losing registrar's servers will update the new DNSKEY information into their respective caches. This may take, for example, 24 hours depending on the frequency with which the resolvers update their records. The method may continue with S5070.

In S5070, the losing registrar may communicate the new DS record back to the registry for publication. This may be accomplished, for example, in a manner similar to DS record updates by registrars re-keying DNS records in their respective zones. In S5080, the registry may publish the new DS record. After the new DS record is published by the registry, resolvers accessing the registry's servers will update the DS record for the domain in their respective caches. This may take, for example, 24-48 hours depending on the frequency with which the resolvers update their records. The method may continue with S5090.

In S5090, the registry may execute steps to verify that the losing registrar has made the expected DNS changes, TTL changes, and/or determine other existing TTLs for domain records held in caches other than the losing registrar. For example, the registry may request DNS information from the losing registrar in S5090. The losing registrar may provide the requested information to the registry in S5092. Once the information is received by the registry, the registry may evaluate the response from the losing registrar to determine, for example, whether the changes to the DNS records and TTLs have been made.

In embodiments, the registry may communicate to the losing registrar that it must remove its own nameservers from the domain and must add in the nameservers of the gaining registrar. The identifying information for the gaining registrars nameservers may be communicated to the registry by the gaining registrar, for example, at the same time, or after, the gaining registrar sends the DNSKEY data to the registry in S5030.

In embodiments, the registry may calculate the TTLs of the various DNS records for the domain, including records in caches not held by the losing registrar, and determine a longest TTL based on all of the known domain records. The registry may use the longest TTL to determine a timing for execution of S5100. In other embodiments, the registry may communicate the longest TTL to one or more of the registrant, and/or gaining registrar, such as when the registrant or the gaining registrar are responsible for initiating further requests for information and/or transfer of the domain hosting. In embodiments, the registry may communicate to the gaining and/or losing registrars, e.g. by poll queue message, that a longest TTL must be allowed to expire before further processing of the domain hosting transfer. The method may continue with S5100.

In S5100, the registry may (prompt the losing registrar for the domain's authinfo. This request may be authenticated, for example, by information provided to the registry from the registrant. The losing registrar may respond in S5102 by providing the domain's authinfo to the registry. In embodiments, the registrant may request this information directly from the losing registrar, however, by allowing the registry to perform more of the necessary functions automatically, without further interaction by the registrant, the process may be streamlined from the user's perspective. The method may continue with S5110.

In S5110, the registry may publish the domain's DNSSEC data to the gaining registrar, e.g. by poll messages or the like. As indicated above, embodiments may include the losing host providing the authinfo to the registrant, in which case the registrant may deliver the authinfo to the gaining registrar. The method may continue with S5120.

In S5120, the gaining registrar, having the domain's authinfo provided in S5110, may initiate the transfer of the domain from the losing registrar to the gaining registrar via a transfer request for the domain to the registry. In embodiments, the registry may alert the losing registrar of the transfer request, and may await an acknowledgement from the losing registrar, and/or may wait a predetermined period of time, before proceeding with the transfer. The method may continue with S5130.

In S5130, the registry may proceed with processing the transfer request. Such processing may include, for example, updating address information for the domain stored by the registry, and/or communicate to the gaining registrar that it may remove the DS record corresponding to the losing registrar's DNSKEY.

Embodiments of the present invention can include systems for implementing the described methods, as well as computer-readable storage medium coded with instructions for causing a computer to execute the described methods. For example, as shown in FIG. 5, server systems such as servers 600, 610, and/or 620, including at least a processor, a memory and an electronic communication device (not shown), may be configured to receive, identify, respond to and/or act on a request, such as those described herein, received over the network 605, such as the Internet. Any of servers 600, 610, and/or 620 may be operated by, for example, an Internet hosting provider, a registrar, and/or a registry as described further herein, and may be in communication with any number of recursive DNS servers generally represented by web devices 630. As described herein, recursive servers 630 may cache DNS-related data for domains of the hosting providers, registrars, and/or registries operating servers 600, 610 and 620.

Requests to transfer a domain from one hosting service to another may be originated by, for example, a registrant, via various systems such as, for example, computers 611, 612, via separate server 613 which may be in wireless or other communication with mobile device(s) 614, picoceil network devices 615, mobile computer 616, or any other network-capable device with the requisite functional capabilities.

The various communications, transmissions, and related functions described herein may be accomplished, for example, via the network 605, and the results of the described processing performed by server systems such as servers 600, 610 and 620, may be displayed, stored and/or distributed according to known techniques. The network 605 may include any number of communication components including wired, cellular, satellite, optical and/or other similar communication links.

The servers 600, 610 and 620, and computers 611, 612, may include any number of processors (not shown) that are coupled to storage devices including a first storage (not shown, typically a random access memory, or “RAM”), second storage (not shown, typically a read only memory, or “ROM”). Both of these storage devices may include any suitable type of computer-readable media, including non-transitory storage media such as flash drives, hard disks, floppy disks, magnetic tape, optical media such as CD-ROM disks, and/or magneto-optical media such as floptical disks. A mass storage device (not shown) may also be used to store programs, data and the like and is typically a secondary storage medium, such as a hard disk that is slower than primary storage. It will be appreciated that the information retained within the mass storage device, may, in appropriate cases, be incorporated in standard manner as part of primary storage as virtual memory. A specific mass storage device such as a CD-ROM may also pass data tali-directionally to the processor.

The servers 600, 610 and 620, and computers 611, 612, may also include an interface that includes one or more input/output devices such as such as video monitors, track balls, mice, keyboards, microphones, touch-sensitive displays, transducer card readers, magnetic or paper tape readers, tablets, styluses, voice or handwriting recognizers, or other known input devices, including other computers. The servers 600, 610 and 620, and computers 611, 612, may be coupled to a computer or other electronic communication network 605 using a network connection. The network 605 can connect various wired, optical, electronic and other known networks to exchange information among servers 600, 610 and 620, computers 611, 612, separate server 613, mobile device(s) 614, picocell network devices 615, mobile computer(s) 616, recursive servers 630, and any other devices with similar functionality. With such a network connection, it is contemplated that the servers 600, 610 and 620, and computers 611, 612 and the processors therein may receive information from the network 605, or may output information to the network 605 in the course of performing the above-described method steps. The above-described devices and materials will be familiar to those of skill in the computer hardware and software arts and need not be individually or exhaustively depicted to be understood by those of skill in the art. The hardware elements described above may be configured (usually temporarily) to act as one or more modules for performing the operations described above.

In addition, embodiments of the present invention further include computer-readable storage media that include program instructions for performing various computer-implemented operations as described herein. The media may also include, alone or in combination with the program instructions, data files, data structures, tables, and the like. The media and program instructions may be those specially designed and constructed for the purposes of the present subject matter, or they may be of the kind available to those having skill in the computer software arts. Examples of computer-readable storage media include magnetic media such as flash drives, hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

The description given above is merely illustrative and is no meant to be an exhaustive list of all possible embodiments, applications or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments.

What is claimed is:

1. A method of transferring a DNSSEC enabled domain from a losing hosting provider to a gaining hosting provider comprising:
receiving a request to transfer the domain from the losing hosting provider to the gaining hosting provider; and
at least one of transferring a DNSKEY or Delegation Signer (DS) record from the gaining hosting provider to the losing hosting provider prior to transferring the domain from the losing hosting provider to the gaining hosting provider, and signing DNS records of the domain with the gaining hosting provider DNSKEY prior to transferring the domain from the losing hosting provider to the gaining hosting provider.

2. The method of claim 1, wherein the method includes both of transferring a DNSKEY or Delegation Signer (DS) record from the gaining hosting provider to the losing hosting provider prior to transferring the domain from the losing hosting provider to the gaining hosting provider, and signing DNS records of the domain with the gaining hosting provider DNSKEY prior to transferring the domain from the losing hosting provider to the gaining hosting provider.

3. The method of claim 1, further comprising:
transferring hosting of the domain from the losing hosting provider to the gaining hosting provider, wherein the domain hosting is transferred from the losing hosting provider to the gaining hosting provider without interruption to a DNSSEC validation for the domain.

4. The method of claim 3, wherein the transfer of the hosting of the domain is executed after expiration of a longest TTL of DNS records of the domain.

5. The method of claim 1, wherein the transfer request is received at the gaining hosting provider.

6. The method of claim 1, wherein the transfer request is received at the losing hosting provider.

7. The method of claim 1, wherein the transfer request is received from the registrant of the domain.

8. The method of claim 1, further comprising:
establishing an undelegated DNSSEC enabled zone for the domain at the gaining hosting provider;
determining a TTL for all DNS records published by the losing hosting provider of the domain; and
delegating to the gaining hosting provider's DNSSEC enabled zone after expiration of a longest TTL of the DNS record TTLs.
discontinuing delegation to the losing hosting provider for the DNSSEC enabled zone.

9. The method of claim 1, wherein the losing hosting provider is supported by a losing registrar and the gaining hosting provider is supported by a gaining registrar, the method further comprising:
receiving the transfer request at the gaining registrar to transfer the domain from the losing registrar to the gaining registrar;
establishing an unpublished DNSSEC enabled zone for the domain at the gaining registrar;
transmitting from the gaining registrar at least one of DNSKEY and Delegation Signer (DS) records for the zone;
receiving domain authorization information for the domain at the gaining registrar;
receiving an initiation request at the gaining registrar to initiate the transfer of the domain; and
after receiving the initiation request, sending a registry request from the gaining registrar to a registry responsible for the domain, the registry request including the domain authorization information.

10. The method of claim 9, wherein the initiation request is received from the registrant of the domain.

11. The method of claim 9, wherein the initiation request is received from the losing registrar.

12. The method of claim 9, wherein the DNSKEY records for the zone include a key-signing key (KSK).

13. The method of claim 9, further comprising:
the gaining registrar automatically confirming that at least one of (a) the DNSKEY records have been published, and (b) the Delegation Signer (DS) records have been added to the domain by the registry,
wherein, the sending of the registry request is conditioned on the automatic confirmation.

14. A method of transferring a DNSSEC enabled domain comprising:
receiving, at a registry responsible for the domain, at least one of DNSKEY and Delegation Signer (DS) records for the domain from a gaining registrar;
providing, from the registry, the at least one of DNSKEY and Delegation Signer (DS) records to a losing registrar;
receiving, at the registry, confirmation that the losing registrar has changed existing DNSSEC data for the domain based on the at least one of DNSKEY and Delegation Signer (DS) records; and
changing address information for the domain at the registry after the confirmation that the existing DNSSEC data for the domain has been changed.

15. The method of claim 14, wherein the registry confirms that the losing registrar has changed the existing DNSSEC data for the domain.

16. The method of claim 14, wherein the registry receives the confirmation that the losing registrar has changed the existing DNSSEC data for the domain from the gaining registrar.

17. The method of claim 14, further comprising:
determining a longest TTL for all DNS records of the domain prior to initiating transfer request to registry;
after expiration of the longest TTL, sending an initiation request from the registry to the losing registrar to request authorization information for the domain; and
after receiving the authorization information from the losing registrar, communicating the authorization information from the registry to the gaining registrar.

18. A hosting provider server system comprising:
a processor; and
a storage medium including instructions for configuring the processor to perform steps including,
receiving a request to transfer a DNSSEC-enabled domain from a losing hosting provider to a gaining hosting provider; and
at least one of transferring a DNSKEY or Delegation Signer (DS) record from the gaining hosting provider to the losing hosting provider prior to transferring the domain from the losing hosting provider to the gaining hosting provider, and signing DNS records of the domain with the gaining hosting provider DNSKEY prior to transferring the domain from the losing hosting provider to the gaining hosting provider.

19. The system of claim 18, further comprising instructions for:
transferring hosting of the domain from the losing hosting provider to the gaining hosting provider, wherein the domain hosting is transferred from the losing hosting provider to the gaining hosting provider without interruption to a DNSSEC validation for the domain.

20. The system of claim 19, wherein the transfer of the hosting of the domain is executed after expiration of a longest TTL of DNS records of the domain.

21. The system of claim 18, further comprising instructions for:
establishing an undelegated DNSSEC enabled zone for the domain at the gaining hosting provider;
determining a TTL for all DNS records of the domain; and
delegating the DNSSEC enabled zone after expiration of a longest TTL, of the DNS record TTLs.

22. The system of claim 18, wherein the DNSKEY records include a key-signing key (KSK).

23. The system of claim 18, wherein the losing hosting provider is supported by a losing registrar and the gaining hosting provider is supported by a gaining registrar, further comprising instructions for steps of:
receiving the transfer request at the gaining registrar to transfer the domain from the losing registrar to the gaining registrar;
establishing an unpublished DNSSEC enabled zone for the domain at the gaining registrar;
transmitting from the gaining registrar at least one of DNSKEY and Delegation Signer (DS) records for the zone;
receiving domain authorization information for the domain at the gaining registrar;
receiving an initiation request at the gaining registrar to initiate the transfer of the domain; and
after receiving the initiation request, sending a registry request from the gaining registrar to a registry responsible for the domain, the registry request including the domain authorization information.

24. The system of claim 23, further comprising instructions for steps of:
the gaining registrar automatically confirming that at least one of (a) the DNSKEY records have been published, and (b) the Delegation Signer (DS) records have been added to the domain by the registry; and
wherein the sending of the registry request is conditioned on the automatic confirmation.

27. The system of claim 18, further comprising instructions for steps of:
receiving the domain transfer request at the gaining hosting provider;
establishing an undelegated DNSSEC enabled zone for the domain at the gaining hosting provider;
transmitting at least one of DNSKEY and Delegation Signer (DS) records for the undelegated zone from the gaining hosting provider to at least one of a registrant of the domain, a registry of the domain, and the losing hosting provider.

28. The system of claim 27, wherein the DNSKEY records for the undelegated zone include a key-signing key (KSK).

29. A registry server system comprising:
a processor; and
a storage medium including instructions for configuring the processor to perform steps including,
receiving, at a registry responsible for a DNSSC-enabled domain, at least one of DNSKEY and Delegation Signer (DS) records for the domain from a gaining registrar;
providing, from the registry, the at least one of DNSKEY and Delegation Signer (DS) records to a losing registrar;
receiving, at the registry, confirmation that the losing registrar has changed an existing DNSSEC data for the domain based on the at least one of DNSKEY and Delegation Signer (DS) records; and
changing address information for the domain at the registry after the confirmation that the existing DNSSEC data for the domain has been changed.

30. The system of claim 29, wherein the registry confirms that the losing registrar has changed the existing DNSSEC data for the domain.

31. The system of claim 29, wherein the registry receives the confirmation that the losing registrar has changed the existing DNSSEC data for the domain from the gaining registrar.

32. The system of claim 29, further comprising instructions for steps of:
determining a longest TTL for all DNS records of the domain;
after expiration of the longest TTL, sending an initiation request from the registry to the losing registrar to request authorization information for the domain; and
after receiving the authorization information from the losing registrar, communicating the authorization information from the registry to the gaining registrar.
